(19) United States
(12) Patent Application Publication
(10) Pub. No.: US 2026/0329229 A1
(43) Pub. Date: Oct. 22, 2026

(54) HOLOGRAM RECORDING DEVICE AND HOLOGRAM RECORDING METHOD

(71) Applicant: National Institute of Information and Communications Technology, Tokyo (JP)

(72) Inventor: Tatsuki TAHARA, Tokyo (JP)

(73) Assignee: National Institute of Information and Communications Technology, Tokyo (JP)

(21) Appl. No.: 19/108,902

(22) PCT Filed: Oct. 20, 2023
(86) PCT No.: PCT/JP2023/038049

§ 371 Date: Mar. 5, 2025

(30) Foreign Application Priority Data
Nov. 8, 2022 (JP) 2022-179119

(51) Int. Cl. G03H 1/04

(52) U.S. Cl. CPC G03H 1/0402; G03H 2001/0415; G03H 2223/24

(57) ABSTRACT

Hologram recording with use of natural light is achieved with a structure that can be manufactured cheaply and easily. A recording device (10) includes: a first reflective element (11) that reflects part of object light; a second reflective element (12) that causes a curvature of a wavefront of first object light reflected by the first reflective element to differ from a curvature of a wavefront of second object light reflected by the second reflective element and that is disposed in proximity to a back surface of the first reflective element; and an image capturing device (13) that captures an image of interference fringes.

### TECHNICAL FIELD

The present invention relates to a hologram recording device and a hologram recording method.

### BACKGROUND ART

Digital holography is a technology in which a computer or an image reconstruction optical system is used to reconstruct an image of a three-dimensional object on the basis of interference fringes obtained by irradiation of the three-dimensional object with light.

Patent Literature 1 discloses an interference imaging device in which a spatial light modulator is used.

Patent Literature 2 discloses a digital holography apparatus in which laser beams having a plurality of wavelengths and a monochrome image capturing device are used.

Patent Literature 3 discloses a digital holography apparatus in which a spatial light modulator is used.

### CITATION LIST

### Patent Literature

### [Patent Literature 1]

Japanese Patent Application Publication, Tokukai, No. 2021-60283

### [Patent Literature 2]

Japanese Patent Application Publication, Tokukai, No. 2017-76038

### [Patent Literature 3]

International Publication No. WO2022/054888

### SUMMARY OF INVENTION

### Technical Problem

However, the technologies described earlier require use of (i) a birefringent spatial light modulator such as a liquid crystal or (ii) a birefringent phase element array and a birefringent lens. A configuration in which a spatial light modulator is used has such a problem that the spatial light modulator is expensive and not easy to manufacture. A configuration in which a birefringent phase element array and a birefringent lens are used has such a problem that both of these optical elements require a high manufacturing technology and are high in manufacturing cost.

An aspect of the present invention has an object to achieve hologram recording with use of natural light with a structure that can be manufactured cheaply and easily.

### Solution to Problem

In order to attain the object, a hologram recording device in accordance with an aspect of the present invention includes: a first reflective element that reflects part of object light and that transmits the other part of the object light; a second reflective element that reflects the object light, which has been transmitted through the first reflective element, so as to cause a curvature of a wavefront of the object light reflected by the first reflective element to differ from a curvature of a wavefront of the object light reflected by the second reflective element and that is disposed in proximity to a back surface of the first reflective element so as to allow the object light reflected by the first reflective element and the object light reflected by the second reflective element to interfere with each other even in a case where the object light is incoherent; and an image capturing device that captures an image of interference fringes which are formed by interference between the object light reflected by the first reflective element and the object light reflected by the second reflective element.

In order to attain the object, a hologram recording method in accordance with an aspect of the present invention includes: a first reflection step of using a first reflective element to reflect part of object light and transmit the other part of the object light; a second reflection step of using a second reflective element disposed in proximity to a back surface of the first reflective element to reflect the object light, which has been transmitted through the first reflective element, so as to (i) cause a curvature of a wavefront of the object light reflected by the first reflective element to differ from a curvature of a wavefront of the object light reflected by the second reflective element and (ii) allow the object light reflected by the first reflective element and the object light reflected by the second reflective element to interfere with each other even in a case where the object light is incoherent; and an image capturing step of capturing an image of interference fringes which are formed by interference between the object light reflected by the first reflective element and the object light reflected by the second reflective element.

### Advantageous Effects of Invention

An aspect of the present invention makes it possible to achieve hologram recording with use of natural light with a structure that can be manufactured cheaply and easily.

### BRIEF DESCRIPTION OF DRAWINGS

FIG. 1 is a view schematically illustrating a configuration of a digital holography apparatus in accordance with an embodiment of the present invention.

FIG. 2 is a view schematically illustrating a configuration of a digital holography apparatus in accordance with an embodiment of the present invention.

FIG. 3 is a view schematically illustrating a configuration of a digital holography apparatus in accordance with an embodiment of the present invention.

FIG. 4 is a view schematically illustrating a configuration of a digital holography apparatus in accordance with an embodiment of the present invention.

FIG. 5 is a view schematically illustrating a configuration of a digital holography apparatus in accordance with an embodiment of the present invention.

FIG. 6 is a view schematically illustrating a configuration of a digital holography apparatus in accordance with an embodiment of the present invention.

FIG. 7 is a view schematically illustrating a configuration of a digital holography apparatus in accordance with an embodiment of the present invention.

### DESCRIPTION OF EMBODIMENTS

### Embodiment 1

### (Configuration of Digital Holography Apparatus 1)

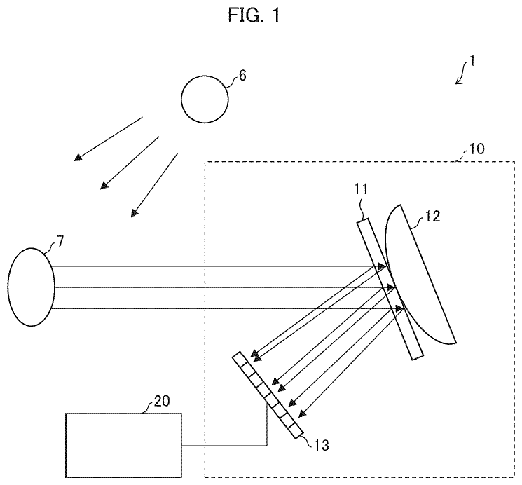

FIG. 1 is a diagram schematically illustrating a configuration of a digital holography apparatus 1 of the present embodiment. The digital holography apparatus 1 includes a recording device 10 (hologram recording device) and a reconstruction device 20. The recording device 10 includes a first reflective element 11, a second reflective element 12, and an image capturing device 13. The reconstruction device 20 can be constituted by a calculator such as a computer.

A light source 6 is a light source that irradiates an object 7 with incoherent light. The light source 6 may be the sun that emits natural light, or may be an illumination device that emits incoherent light, such as a halogen lamp or a light-emitting diode.

The object 7 is a subject. Light that comes from the object 7 is referred to as object light. The object light is, for example, light reflected, diffracted, or scattered by the object 7, or fluorescence emitted from the object 7. The object light is incoherent light with low coherence (e.g., natural light, fluorescence, or phosphorescence).

The first reflective element 11 reflects part of object light that has entered the first reflective element 11, and transmits the other part of the object light. The first reflective element 11 is, for example, a semitransparent mirror. The first reflective element 11 has a plate-like shape, and a reflecting surface of the first reflective element 11 is planar. The object 7 side surface of the first reflective element 11 is regarded as a front surface, and a surface thereof that faces away from the object 7 is regarded as a back surface. The front surface of the first reflective element 11 may be the reflecting surface (deposited with aluminum or the like), or the back surface thereof may be the reflecting surface. The object light reflected by the first reflective element 11 is referred to as first object light. The first object light travels toward the image capturing device 13.

The second reflective element 12 reflects the object light, which has been transmitted through the first reflective element 11, so as to cause a curvature of a wavefront of the first object light to differ from a curvature of a wavefront of the object light reflected by the second reflective element 12. The object light reflected by the second reflective element 12 is referred to as second object light. A curvature of a reflecting surface of the first reflective element 11 differs from a curvature of a reflecting surface of the second reflective element 12. The second reflective element 12 is, for example, a convex mirror. A reflecting surface of the convex mirror may be, for example, a spherical surface, a cylindrical surface, or an aspherical curved surface. The second reflective element 12 reflects the object light, which has been transmitted through the first reflective element 11, so that a curvature of the object light is changed. The second object light reflected by the second reflective element 12 passes through the first reflective element 11 again and travels toward the image capturing device 13.

Further, the second reflective element 12 is disposed in proximity to the back surface of the first reflective element 11 so as to allow the first object light and the second object light to interfere with each other. For example, the second reflective element 12 is disposed in proximity to the back surface of the first reflective element 11 so that the first object light and the second object light form interference fringes on an image capturing plane of the image capturing device 13 (to a degree that allows the first object light and the second object light to self-interfere with each other). In this embodiment, the second reflective element is disposed immediately behind the first reflective element 11. The second reflective element 12 may be disposed such that a part (center) of the second reflective element 12 is in contact with the back surface of the first reflective element 11. Alternatively, the second reflective element 12 and the back surface of the first reflective element 11 may be away from each other. Another thin film may be provided between the second reflective element 12 and the first reflective element 11. However, in order for the first object light and the second object light to form the interference fringes, an optical path length difference between the first object light and the second object light in at least a partial region of the second reflective element 12 needs to be not more than a coherence length of the object light, which is natural light. In at least the partial region including the center of the second reflective element 12, a back and forth optical path length between the reflecting surface of the first reflective element 11 and the reflecting surface of the second reflective element 12 is not more than the coherence length. Thus, the first reflective element 11 has a thickness that is preferably, for example, not more than 1 mm, and more preferably not more than 100 μm. The back surface of the first reflective element 11 which back surface is the reflecting surface allows the optical path length difference to be shorter. A shorter optical path length difference between the first object light and the second object light makes it possible to obtain clearer interference fringes.

For example, a spatial light modulator commonly has a thickness that exceeds several mm. In a case where another optical element (e.g., a spatial light modulator) that changes an optical phase distribution is present between the first reflective element 11 and the second reflective element 12, the optical path length difference between the first object light and the second object light exceeds the coherence length. Thus, in the recording device 10, no other optical element (e.g., spatial light modulator) is provided between the first reflective element 11 and the second reflective element 12.

The image capturing device 13 captures an image of interference fringes (a hologram) formed by interference between the first object light and the second object light. The image capturing device 13 has an image capturing plane in which a plurality of pixels for capturing an image are arranged two-dimensionally. The image capturing device 13 records an intensity of light that has reached the image capturing plane. The image capturing device 13 has an image capturing element such as a charge coupled device (CCD) or a complementary metal-oxide semiconductor (CMOS). Interference between the first object light and the second object light forms the interference fringes on the image capturing plane. The interference fringes are a hologram having information pertaining to the object light. The image capturing device 13 outputs, to the reconstruction device 20, image data of the interference fringes whose image has been captured.

The reconstruction device 20 carries out an image reconstruction process with respect to the hologram recorded by the recording device 10, and generates a reconstructed image. The reconstruction device 20 is constituted by, for example, a computer. Note that in the image reconstruction process, the reconstruction device 20 can obtain a reconstructed image of the subject at any depth position by using the object light to perform diffraction integration. The reconstruction device 20 can use a known reconstruction method, and thus is not described in detail here.

### (Effect of Digital Holography Apparatus 1)

In the present embodiment, the digital holography apparatus 1 splits object light into first object light and second object light, and causes a curvature of a wavefront of the second object light to differ from a curvature of a wavefront of the first object light. Further, the second reflective element 12 is disposed in proximity to the first reflective element 11 so that the first object light and the second object light form interference fringes. Thus, even in a case where the object light is incoherent object light, the first object light and the second object light into which the object light has been split can self-interfere with other to form the interference fringes. As described above, in the digital holography apparatus 1, by disposing the first reflective element 11 and the second reflective element 12 in proximity to each other without using any spatial light modulator, it is possible to achieve recording of a hologram with use of natural light with a structure that can be manufactured cheaply and easily. Furthermore, by using the principle of Newton's rings, it is possible to obtain clear interference fringes even with use of natural light. In other words, as compared with an apparatus in which a spatial light modulator is used, the digital holography apparatus 1 makes it possible to obtain clear interference fringes even with use of light with lower coherence (a shorter coherence length). Moreover, the digital holography apparatus 1 can continuously capture images at a higher speed as compared with an apparatus in which phase-shifting interferometry with use of a spatial light modulator is used.

### (Variation)

In a case where the reflecting surface of the second reflective element 12 is a spherical surface, interference fringes caused by the object light that comes from one point of the object 7 are ring-shaped (typical Newton's rings). Since the object 7 is understood as a set of points, actually formed interference fringes are a superposition of a plurality of rings. In a case where the reflecting surface of the second reflective element 12 is a cylindrical surface, interference fringes caused by the object light that comes from one point of the object 7 are parallel linear fringes.

Note that the second reflective element 12 may be a concave mirror. This also applies to the embodiments described later.

The reflecting surface of the first reflective element 11 may be a convex surface or a concave surface. The reflecting surface (a curved surface deposited with aluminum or the like) of the first reflective element 11, which is a semitransparent mirror, may be the back surface or the front surface. In this case, the reflecting surface of the second reflective element 12 may be planar. Both the reflecting surface of the first reflective element 11 and the reflecting surface of the second reflective element 12 may be curved surfaces. The curvature of the reflecting surface of the first reflective element 11 need only differ from the curvature of the reflecting surface of the second reflective element 12. This also applies to the embodiments described later.

Further, interference fringes at a specific wavelength may be obtained by introducing, into an optical path of the object light, an element that selectively transmits a wavelength, such as a color filter.

Note that a spatial light modulator may be provided between the first reflective element 11 and the object 7 or between the first reflective element 11 and the image capturing device 13.

In the digital holography apparatus 1, it is also possible to use a laser light source as a light source and use coherent object light to capture an image of interference fringes. This also applies to the embodiments described later.

### Embodiment 2

The following description will discuss another embodiment of the present invention. Note that for convenience, members having functions identical to those of the respective members described in Embodiment 1 are given respective identical reference numerals, and a description of those members is omitted.

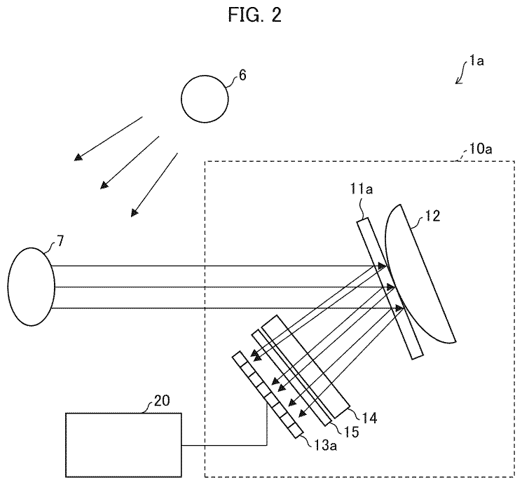

FIG. 2 is a diagram schematically illustrating a configuration of a digital holography apparatus 1a of the present embodiment. The digital holography apparatus 1a includes a recording device 10a (hologram recording device) and a reconstruction device 20. The recording device 10a includes a first reflective element 11a, a second reflective element 12, an optical path length-adjusting element 14, a polarization conversion element 15, and an image capturing device 13a. The polarization conversion element 15 is disposed between the first reflective element 11a and the image capturing device 13a. The optical path length-adjusting element 14 is disposed between the first reflective element 11a and polarization conversion element 15.

One direction orthogonal to a propagation direction of object light is defined as a first direction, and a direction orthogonal to the first direction and the propagation direction of the object light is defined as a second direction. In this embodiment, the first direction is expressed as a vertical direction, and the second direction is expressed as a horizontal direction. Object light that comes from an object 7 includes first object light and second object light that have polarization directions which differ from each other. In this embodiment, the first object light is light that has a polarized light component in the first direction, and the second object light is light that has a polarized light component in the second direction.

The first reflective element 11a reflects the first object light and transmits the second object light. The first reflective element 11a is, for example, a wire grid polarizer, a photonic crystal, a structural birefringent material, or a nanomaterial that reflects polarized light in a specific direction and that transmits the other polarized light. The second object light, which has been transmitted through the first reflective element 11a, is reflected by the second reflective element 12, passes through the first reflective element 11a again, and merges with the first object light.

The optical path length-adjusting element 14 reduces an optical path length difference between the first object light and the second object light by delaying a phase of the first object light. The optical path length-adjusting element 14 is, for example, a birefringent phase plate. A slow axis of the birefringent phase plate is parallel to the polarization direction of the first object light. Using the optical path length-adjusting element 14 to reduce the optical path length difference makes it possible to obtain clearer interference fringes. Note, however, that the optical path length-adjusting element 14 can be omitted.

The polarization conversion element 15 changes the polarization directions of the first object light and the second object light so that the first object light and the second object light interfere with each other. The polarization conversion element 15 is, for example, a quarter-wave plate. The quarter-wave plate is disposed such that a slow axis thereof is between the vertical direction and the horizontal direction. In this embodiment, an angle between the slow axis and the horizontal direction is 45°. The polarization conversion element 15 converts the first object light into circularly polarized light (elliptically polarized light) in a certain rotation direction and converts the second object light into circularly polarized light (elliptically polarized light) in a counter-rotation direction.

The image capturing device 13a is a polarization image sensor. The image capturing device 13a has a plurality of pixels for carrying out image capture in accordance with a plurality of polarization directions. The first object light and the second object light are circularly polarized light rays that rotate counter to each other. Thus, for each of the plurality of polarization directions, the image capturing device 13a captures an image of a plurality of interference fringes that differ in phase difference between the first object light and the second object light.

According to the recording device 10a, it is possible to obtain a plurality of interference fringes (a hologram) having different phase differences. This enables the reconstruction device 20 to generate a clear reconstructed image by using, for example, a known phase-shifting method and known diffraction integration to carry out an image reconstruction process.

Note that the polarization conversion element 15 may be a polarizer which allows polarized light in an oblique direction (between the first direction and the second direction) to pass therethrough. In this case, the image capturing device 13a may be an ordinary image sensor instead of the polarization image sensor.

### Embodiment 3

The following description will discuss still another embodiment of the present invention. Note that for convenience, members having functions identical to those of the respective members described in Embodiments 1 and 2 are given respective identical reference numerals, and a description of those members is omitted.

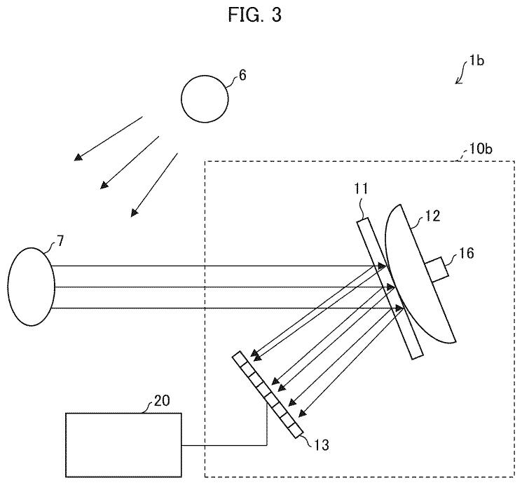

FIG. 3 is a diagram schematically illustrating a configuration of a digital holography apparatus 1b of the present embodiment. The digital holography apparatus 1b includes a recording device 10b (hologram recording device) and a reconstruction device 20. The recording device 10b includes a first reflective element 11, a second reflective element 12, a vibration body 16 (displacement element) and an image capturing device 13. The object 7 side surface of the second reflective element 12 is regarded as a front surface, and a surface thereof that faces away from the object 7 is regarded as a back surface. The vibration body 16 is connected to the back surface of the second reflective element 12.

The vibration body 16 causes the second reflective element 12 to vibrate. That is, the vibration body 16 displaces the second reflective element 12. Note that the vibration body 16 does not displace the first reflective element 11. The vibration body 16 is, for example, a piezoelectric element. Second object light, which has been transmitted through the first reflective element 11, is reflected by the second reflective element 12 that vibrates, passes through the first reflective element 11 again, and merges with first object light. Note here that vibration magnitudes (displacement ranges) of the vibration body 16 and the second reflective element 12 connected to the vibration body 16 are within a range which satisfies a condition that a back and forth optical path length between a reflecting surface of the first reflective element 11 and a reflecting surface of the second reflective element 12 is not more than a coherence length. The vibration body 16 is controlled by, for example, the reconstruction device 20.

The image capturing device 13 captures an image of interference fringes (a hologram) formed in a case where the first object light and the second object light reflected by the front surface of the second reflective element 12 that vibrates merge and interfere with each other. The image capturing device 13 carries out image capture a plurality of times. For example, the image capturing device 13 captures an image of interference fringes at a first time at which the second reflective element 12 is displaced to the first reflective element 11 side by the vibration body 16. The image capturing device 13 captures an image of interference fringes at a second time at which the second reflective element 12 is displaced to an opposite side from the first reflective element 11 by the vibration body 16. The first time and the second time differ in optical path length of the second object light and thus differ in phase of the second object light in an image capturing plane. This makes it possible to obtain a plurality of holograms that have different phase differences between the first object light and the second object light. From the plurality of holograms that have different phase differences, a clearer reconstructed image can be obtained than from a single hologram with use of a known phase-shifting method or computationally coherent multiplexing algorithm.

Using a piezoelectric element makes it possible to (i) make an optical path length difference between the first object light and the second object light not more than a coherence length of natural light and (ii) obtain a plurality of holograms that have different phase differences. Further, using the piezoelectric element makes it possible to continuously capture images of a plurality of holograms at a high speed.

### (Variation)

Note that the vibration body 16 may be provided to the first reflective element 11 to displace only the first reflective element 11.

### Embodiment 4

The following description will discuss still another embodiment of the present invention. Note that for convenience, members having functions identical to those of the respective members described in Embodiments 1 to 3 are given respective identical reference numerals, and a description of those members is omitted.

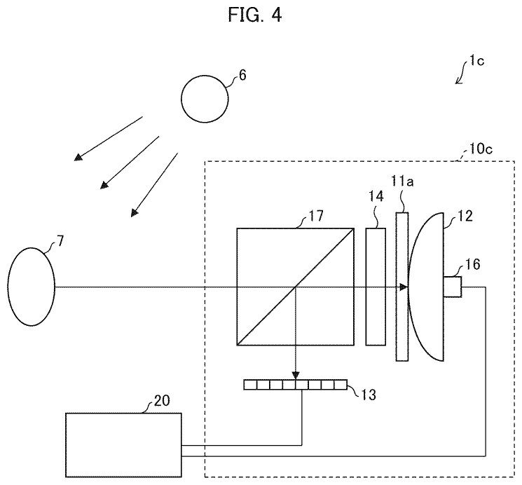

FIG. 4 is a diagram schematically illustrating a configuration of a digital holography apparatus 1c of the present embodiment. The digital holography apparatus 1c includes a recording device 10c (hologram recording device) and a reconstruction device 20. The recording device 10c includes a first reflective element 11a, a second reflective element 12, a vibration body 16, an optical path length-adjusting element 14, a polarization beam splitter 17, and an image capturing device 13.

The polarization beam splitter 17 and the optical path length-adjusting element 14 are disposed between an object 7 and the first reflective element 11a. The polarization beam splitter 17 is disposed further toward the object 7 than the optical path length-adjusting element 14. The optical path length-adjusting element 14 is disposed further toward the first reflective element 11a than the polarization beam splitter 17.

For example, the polarization beam splitter 17 transmits polarized light in a polarization direction that is tilted 45° clockwise with respect to the first direction, which has been described in Embodiment 2, when viewed toward a traveling direction of first object light, and reflects polarized light in a polarization direction that is tilted 45° counterclockwise with respect to the first direction. For example, the first reflective element 11a reflects polarized light whose polarization direction is the first direction, which has been described in Embodiment 2, and transmits polarized light whose polarization direction is the second direction, which has been described in Embodiment 2.

Of object light from the object 7, a component in the polarization direction that is tilted 45° clockwise passes through the polarization beam splitter 17. The object light, which has been transmitted through the polarization beam splitter 17, passes through the optical path length-adjusting element 14. The optical path length-adjusting element 14 delays a phase of polarized light which is contained in the object light and whose polarization direction is the first direction. Of the object light that has been transmitted through the optical path length-adjusting element 14, the polarized light (first object light) whose polarization direction is the first direction is reflected by the first reflective element 11a, and the polarized light (second object light) whose polarization direction is the second direction is transmitted through the first reflective element 11a. The second object light is reflected by the second reflective element 12, passes through the first reflective element 11a again, and merges with the first object light. The first object light and the second object light pass through the optical path length-adjusting element 14 again and enter the polarization beam splitter 17.

Part of the first object light and part of the second object light (component in the polarization direction which is tilted 45° counterclockwise from the first direction) are reflected by the polarization beam splitter 17 and enter the image capturing device 13. The part of the first object light and the part of the second object light interfere with each other because the polarization directions of the part of the first object light and the part of the second object light are aligned by the polarization beam splitter 17.

The vibration body 16 vibrating as in the case of Embodiment 3 makes it possible to obtain a reconstructed image which is clearer than that obtained from a single hologram. Further, it is possible to reduce an optical path length difference between the first object light and the second object light that enter the image capturing device 13. This makes it possible to obtain a clear reconstructed image.

### (Variation)

Note that the vibration body 16 may be provided to the first reflective element 11a to displace only the first reflective element 11a.

As in the case of Embodiment 2, the optical path length-adjusting element 14 can be omitted.

### Embodiment 5

The following description will discuss still another embodiment of the present invention. Note that for convenience, members having functions identical to those of the respective members described in Embodiments 1 to 4 are given respective identical reference numerals, and a description of those members is omitted.

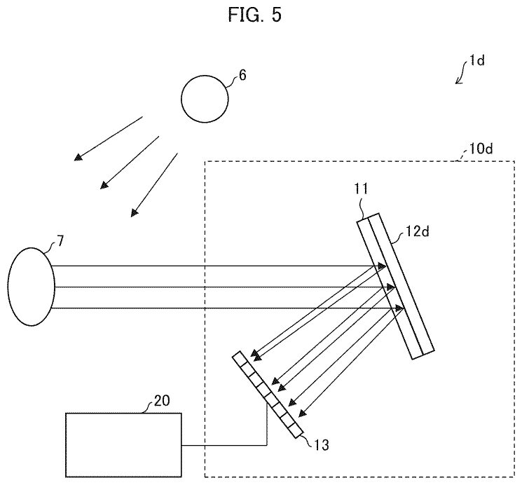

FIG. 5 is a diagram schematically illustrating a configuration of a digital holography apparatus 1d of the present embodiment. The digital holography apparatus 1d includes a recording device 10d (hologram recording device) and a reconstruction device 20. The recording device 10d includes a first reflective element 11, a diffraction element 12d, and an image capturing device 13.

The diffraction element 12d (second reflective element) is a reflective diffraction grating (reflective diffraction element) which causes a phase distribution similar to that of a convex mirror to occur in second object light reflected (diffracted). The diffraction element 12d may be, for example, a holographic optical element. A wavefront of the second object light reflected by the diffraction element 12d is similar to that in Embodiment 1.

The diffraction element 12d is disposed in proximity, in the meaning similar to that in Embodiment 1, to a back surface of the first reflective element 11 so as to allow first object light reflected by a front surface of the first reflective element 11 and the second object light reflected by the diffraction element 12d to interfere with each other.

The first object light and the second object light that have merged together enter the image capturing device 13 and interfere with each other.

In Embodiment 5, as compared with Embodiment 1, the convex mirror is merely replaced with the diffraction element 12d, and the state (wavefront shape) and the path of the second object light are the same as those in Embodiment 1. In Embodiment 5, an optical path length difference is smaller than in Embodiment 1. This makes it possible to obtain interference fringes that are clearer than those in Embodiment 1.

### (Variation)

Further, in a case where the object 7 side surface of the diffraction element 12d is regarded as a front surface, and a surface thereof that faces away from the object 7 is regarded as a back surface, the vibration body 16 of Embodiment 3 may be connected to the back surface of the diffraction element 12d.

Furthermore, the diffraction element 12d may be a reflective diffraction grating which causes a phase distribution similar to that of a concave mirror to occur in the second object light reflected (diffracted).

Note that the second reflective element 12 can be replaced with the diffraction element 12d in each of the foregoing embodiments.

The following description will discuss still another embodiment of the present invention. Note that for convenience, members having functions identical to those of the respective members described in Embodiments 1 to 5 are given respective identical reference numerals, and a description of those members is omitted.

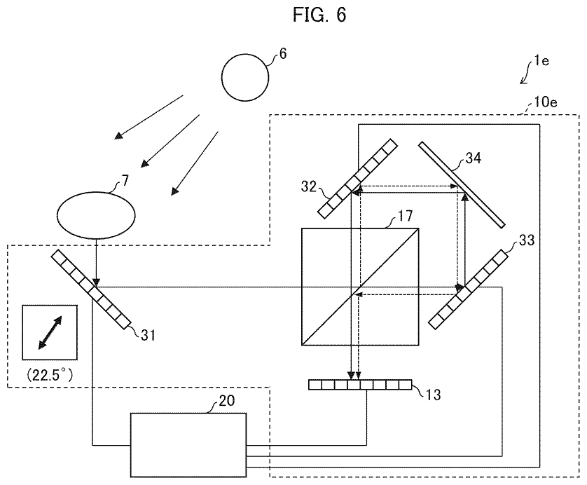

FIG. 6 is a diagram schematically illustrating a configuration of a digital holography apparatus le of the present embodiment. The digital holography apparatus le includes a recording device 10e (hologram recording device) and a reconstruction device 20. The recording device 10e includes a polarization beam splitter 17, a first spatial light modulator 31, a second spatial light modulator 32, a third spatial light modulator 33, a mirror 34, and an image capturing device 13. Incoherent object light from an object 7 contains light in various states of polarization.

The first spatial light modulator 31 is a reflective spatial light modulator. The first spatial light modulator 31 carries out, in a time-sharing manner, any of the following operations: (1) a first operation of giving no phase modulation; (2) a second operation of operating as a half-wave plate; and (3) a third operation of operating as a quarter-wave plate. An operation axis (slow axis) of the first spatial light modulator 31 is tilted 22.5° (tilted by an angle that is more than 0° and less than 45°) from a first direction (vertical direction).

The polarization beam splitter 17 reflects polarized light whose polarization direction is the first direction, and transmits polarized light whose polarization direction is a second direction (horizontally polarized light).

The second spatial light modulator 32 is a reflective spatial light modulator in which a plurality of first cells and a plurality of second cells are randomly distributed. The plurality of first cells change, into a wavefront such as a spherical wavefront or a Fresnel lens-pattern wavefront, a wavefront of the polarized light whose polarization direction is the first direction. The plurality of second cells delay, by a predetermined amount, a phase of the polarized light whose polarization direction is the first direction.

The third spatial light modulator 33 is a reflective spatial light modulator in which a plurality of third cells and a plurality of fourth cells are randomly distributed. The plurality of third cells change, into a wavefront such as a spherical wavefront or a Fresnel lens-pattern wavefront, a wavefront of the polarized light whose polarization direction is the second direction. The plurality of fourth cells delay, by a predetermined amount, a phase of the polarized light whose polarization direction is the second direction.

### (During First Operation)

The first spatial light modulator 31 merely reflects the object light from the object 7.

Next, the polarized light (first object light) which is contained in the object light and whose polarization direction is the first direction is reflected by the polarization beam splitter 17 and is modulated by the second spatial light modulator 32. The first object light reflected by the second spatial light modulator 32 contains a first component whose wavefront has been modulated and a second component which has been subjected to phase modulation. The first object light is reflected by the mirror 34 and the third spatial light modulator 33, is reflected by the polarization beam splitter 17 again, and enters the image capturing device 13.

In contrast, the polarized light (second object light) which is contained in the object light and whose polarization direction is the second direction is transmitted through the polarization beam splitter 17 and is modulated by the third spatial light modulator 33. The second object light reflected by the third spatial light modulator 33 contains a third component whose wavefront has been modulated and a fourth component which has been subjected to phase modulation. The second object light is reflected by the mirror 34 and the second spatial light modulator 32, is transmitted through the polarization beam splitter 17 again, and enters the image capturing device 13.

The image capturing device 13 captures an image of a hologram in which interference fringes formed by interference between two components of the first object light are superimposed on interference fringes formed by interference between two components of the second object light.

### (During Second Operation)

The first spatial light modulator 31 operates as a half-wave plate. The first spatial light modulator 31 converts, into polarized light whose polarization direction is the first direction, polarized light which is contained in the object light from the object 7 and whose polarization direction is tilted 45° from the first direction, and converts, into polarized light whose polarization direction is the second direction, polarized light which is contained in the object light from the object 7 and whose polarization direction is tilted −45° from the first direction.

Subsequent operations carried out by the second spatial light modulator 32 and the third spatial light modulator 33 are the same as those carried out during the first operation. In this case, it follows that the first object light (polarized light in the first direction) whose image is captured by the image capturing device 13 is light which was polarized light, whose polarization direction was tilted 45° from the first direction, before the polarized light was reflected by the first spatial light modulator 31. That is, the image capturing device 13 captures an image of a hologram in which interference fringes formed by light which is contained in the object light from the object 7 and which was polarized light whose polarization direction was originally tilted 45° from the first direction are superimposed on interference fringes formed by light which is contained in the object light from the object 7 and which was polarized light whose polarization direction was originally tilted −45° from the first direction.

### (During Third Operation)

The first spatial light modulator 31 operates as a quarter-wave plate. The first spatial light modulator 31 converts, into polarized light whose polarization direction is tilted −22.5° from the first direction, first circularly polarized light (elliptically polarized light in a first rotation direction) which is contained in the object light from the object 7. The polarized light is a sum of a polarized light component in the first direction, the polarized light component corresponding to cos (22.5°) of an amplitude, and a polarized light component in the second direction, the polarized light component corresponding to sin (22.5°) of the amplitude. The first spatial light modulator 31 converts, into polarized light whose polarization direction is tilted 67.5° from the first direction, second circularly polarized light (elliptically polarized light in a second rotation direction that is reverse to the first rotation direction) which is contained in the object light from the object 7. The polarized light is a sum of a polarized light component in the first direction, the polarized light component corresponding to sin (22.5°) of the amplitude, and a polarized light component in the second direction, the polarized light component corresponding to cos (22.5°) of the amplitude. Thus, simultaneous equations are established from a hologram whose image has been captured, so that information pertaining to circularly polarized light (the first circularly polarized light and the second circularly polarized light) can be identified through computation based on computationally coherent multiplexing.

Subsequent operations carried out by the second spatial light modulator 32 and the third spatial light modulator 33 are those carried out during the first operation. That is, the image capturing device 13 captures an image of a hologram in which interference fringes formed by light which is contained in the object light from the object 7 and which was originally the first circularly polarized light are superimposed on interference fringes formed by light which is contained in the object light from the object 7 and which was originally the counter-rotating second circularly polarized light.

The image capturing device 13 thus captures, in a time-sharing manner, an image of a plurality of holograms including information pertaining to vertically polarized light, horizontally polarized light, 45°-tilted linearly polarized light, −45°-tilted linearly polarized light, the first circularly polarized light, and the counter-rotating second circularly polarized light that are contained in the object light from the object 7. Further, the digital holography apparatus le has an optical system that uses the polarization beam splitter 17, the second spatial light modulator 32, and the third spatial light modulator 33 to cause the object light to go around once (in both directions). This makes it possible to achieve a compact configuration while using a reflective spatial light modulator. Further, the mirror 34 may be omitted to achieve a more compact configuration.

The reconstruction device 20 uses a known algorithm to obtain a reconstructed image of each polarized light from a plurality of holograms (a plurality of multiplex holograms) in which a plurality of interference fringes are superimposed. The known algorithm can be, for example, a computationally coherent multiplexing algorithm as disclosed in Patent Literature 3. This makes it possible to obtain polarization information (e.g., a full Stokes parameter) including a circularly polarized light component, without using any polarization imaging camera.

Note that the first spatial light modulator 31 can be replaced with a transmission-type birefringent phase modulator whose modulation amount is variable or with a plurality of switchable wave plates.

### Embodiment 7

The following description will discuss still another embodiment of the present invention. Note that for convenience, members having functions identical to those of the respective members described in Embodiments 1 to 6 are given respective identical reference numerals, and a description of those members is omitted.

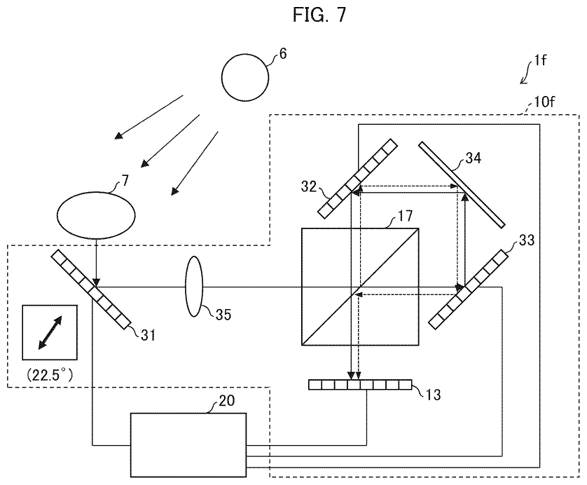

FIG. 7 is a diagram schematically illustrating a configuration of a digital holography apparatus 1f of the present embodiment. The digital holography apparatus 1f includes a recording device 10f (hologram recording device) and a reconstruction device 20. Embodiment 7 differs from Embodiment 6 in that the recording device 10f includes a lens 35 between a first spatial light modulator 31 and a polarization beam splitter 17.

A focus of the lens 35 is located on a second spatial light modulator 32 and on a third spatial light modulator 33. The lens 35 functions so as to operate the second spatial light modulator 32 and the third spatial light modulator 33 in a Fourier transform plane.

The second spatial light modulator 32 randomly distributes a plurality of first cells and a plurality of second cells at or near a center (at or near an optical axis) thereof. Similarly, the third spatial light modulator 33 randomly distributes a plurality of third cells and a plurality of fourth cells at or near a center (at or near an optical axis) thereof. Alternatively, a first cell and a third cell may be circular or rectangular regions, and a second cell and a fourth cell may be other regions.

This enables an image capturing device 13 to capture an image of a plurality of multiplex holograms including quantitative phase information of an object 7. For example, even in the case of a transparent object, a multiplex hologram can be obtained.

Aspects of the present invention can also be expressed as follows:

A hologram recording device in accordance with a first aspect of the present invention includes: a first reflective element that reflects part of object light and that transmits the other part of the object light; a second reflective element that reflects the object light, which has been transmitted through the first reflective element, so as to cause a curvature of a wavefront of the object light reflected by the first reflective element to differ from a curvature of a wavefront of the object light reflected by the second reflective element and that is disposed in proximity to a back surface of the first reflective element so as to allow the object light reflected by the first reflective element and the object light reflected by the second reflective element to interfere with each other even in a case where the object light is incoherent; and an image capturing device that captures an image of interference fringes which are formed by interference between the object light reflected by the first reflective element and the object light reflected by the second reflective element.

According to the above configuration, the first reflective element and the second reflective element that is disposed in proximity to a back surface of the first reflective element make it possible to form interference fringes (a superposition of so-called Newton's rings that are formed by each point of an object) even in a case where object light is incoherent light. Thus, for example, without the need for any spatial light modulator, it is possible to achieve hologram recording with use of natural light with a structure that can be manufactured cheaply and easily.

In a second aspect of the present invention, a hologram recording device may be configured such that, in the first aspect, no spatial light modulator is provided between the first reflective element and the second reflective element.

In a third aspect of the present invention, a hologram recording device may be configured such that, in the first or second aspect, the second reflective element is disposed in proximity to the back surface of the first reflective element so that an optical path length difference between the object light reflected by the first reflective element and the object light reflected by the second reflective element is not more than a coherence length of the incoherent object light in at least a partial region of the second reflective element.

In a fourth aspect of the present invention, a hologram recording device may be configured such that, in the first to third aspects, the second reflective element is a convex mirror, a concave mirror, or a reflective diffraction element.

In a fifth aspect of the present invention, a hologram recording device may be configured such that, in the first to fourth aspects, the object light includes first object light and second object light that have polarization directions which differ from each other, and the first reflective element reflects the first object light and transmits the second object light, the hologram recording device further including, between the first reflective element and the image capturing device, a polarization conversion element which changes the polarization directions of the first object light and the second object light so that the first object light and the second object light interfere with each other.

A hologram recording method in accordance with a sixth aspect of the present invention includes: a first reflection step of using a first reflective element to reflect part of object light and transmit the other part of the object light; a second reflection step of using a second reflective element disposed in proximity to a back surface of the first reflective element to reflect the object light, which has been transmitted through the first reflective element, so as to (i) cause a curvature of a wavefront of the object light reflected by the first reflective element to differ from a curvature of a wavefront of the object light reflected by the second reflective element and (ii) allow the object light reflected by the first reflective element and the object light reflected by the second reflective element to interfere with each other even in a case where the object light is incoherent; and an image capturing step of capturing an image of interference fringes which are formed by interference between the object light reflected by the first reflective element and the object light reflected by the second reflective element.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1a, 1b, 1c, 1d, 1e, 1f Digital holography apparatus
6 Light source
7 Object
10, 10a, 10b, 10c, 10d, 10e, 10f Recording device (hologram recording device)
11, 11a First reflective element
12 Second reflective element
12d Diffraction element (second reflective element)
13, 13a Image capturing device
14 Optical path length-adjusting element
15 Polarization conversion element
16 Vibration body
17 Polarization beam splitter (polarization conversion element)
20 Reconstruction device
31 First spatial light modulator
32 Second spatial light modulator
33 Third spatial light modulator
34 Mirror
35 Lens

1. A hologram recording device comprising:
a first reflective element that reflects part of object light and that transmits the other part of the object light;
a second reflective element that reflects the object light, which has been transmitted through the first reflective element, so as to cause a curvature of a wavefront of the object light reflected by the first reflective element to differ from a curvature of a wavefront of the object light reflected by the second reflective element and that is disposed in proximity to a back surface of the first reflective element so as to allow the object light reflected by the first reflective element and the object light reflected by the second reflective element to interfere with each other even in a case where the object light is incoherent; and
an image capturing device that captures an image of interference fringes which are formed by interference between the object light reflected by the first reflective element and the object light reflected by the second reflective element.

2. The hologram recording device according to claim 1, wherein no spatial light modulator is provided between the first reflective element and the second reflective element.

3. The hologram recording device according to claim 1, wherein the second reflective element is disposed in proximity to the back surface of the first reflective element so that an optical path length difference between the object light reflected by the first reflective element and the object light reflected by the second reflective element is not more than a coherence length of the incoherent object light in at least a partial region of the second reflective element.

4. The hologram recording device according to claim 1, wherein the second reflective element is a convex mirror, a concave mirror, or a reflective diffraction element.

5. The hologram recording device according to claim 1, wherein
the object light includes first object light and second object light that have polarization directions which differ from each other, and
the first reflective element reflects the first object light and transmits the second object light,
said hologram recording device further comprising, between the first reflective element and the image capturing device, a polarization conversion element which changes the polarization directions of the first object light and the second object light so that the first object light and the second object light interfere with each other.

6. A hologram recording method comprising:
a first reflection step of using a first reflective element to reflect part of object light and transmit the other part of the object light;
a second reflection step of using a second reflective element disposed in proximity to a back surface of the first reflective element to reflect the object light, which has been transmitted through the first reflective element, so as to (i) cause a curvature of a wavefront of the object light reflected by the first reflective element to differ from a curvature of a wavefront of the object light reflected by the second reflective element and (ii) allow the object light reflected by the first reflective element and the object light reflected by the second reflective element to interfere with each other even in a case where the object light is incoherent; and
an image capturing step of capturing an image of interference fringes which are formed by interference between the object light reflected by the first reflective element and the object light reflected by the second reflective element.
